(19) United States
(12) Patent Application Publication
(10) Pub. No.: US 2012/0124430 A1
(43) Pub. Date: May 17, 2012

(54) Mechanism to Prevent Escaped Associations in Multi-Association RPC Based Protocols

(75) Inventors: Srinivas Dharmasanam, San Jose, CA (US); Eitan Ben-Nun, San Jose, CA (US); Saravanan Agasaveeran, Fremont, CA (US)

(73) Assignee: Cisco Technology, Inc., San Jose, CA (US)

(21) Appl. No.: 12/948,457

(22) Filed: Nov. 17, 2010

(51) Int. Cl. G06F 15/16; G06F 11/07

(52) U.S. Cl. 714/48; 709/227; 709/238; 714/E11.025

(57) ABSTRACT

Consistent with embodiments of the present invention, a method may be provided comprising sending a first bind request with an association group ID of zero. A first association group with a first association group ID may then be created. The first association group ID may be switched to a second association group ID in an acknowledgement message. A second bind request may then be sent with the second association group ID. The second association group ID may be switched to the first association group ID in the second bind request after the bind request has been sent. After receiving the second bind request, it may be determined whether the association group ID in the second bind request is the same as the first association group ID. A failure message may be sent if the association group ID in the second bind request is not the same as the first association group ID.

### TECHNICAL FIELD

The present disclosure relates generally to the prevention of escaped RPC associations which can lead to application data corruption. The mechanism described is used to preserve application session integrity that use multi-association (e.g. multiple TCP connections) RPC based protocols.

### BACKGROUND

In a typical Enterprise deployment, users of an electronic mail application may be accessing a centralized mail server over a wide area network. The users may communicate data traffic between the electronic mail application and the centralized mail server across a plurality of devices, such as routers and switches. The devices may be managed from sources both internal and external to the Enterprise deployment. As a result, current systems may not be able to ensure that all the TCP connections from a given client are always going to go through the same set of computing devices. There is a need for a system which can ensure that all the TCP connections from a given client are always going to go through a set of computing devices as part of their path between client and server. When “TCP connections” are mentioned throughout this application, it should be understood that the term comprises an RPC association in general. A TCP connection is one type of many RPC associations and embodiments of the present invention may be applicable to any type of RPC association (UDP, HTTP, etc.). Under the cases where not all the RPC associations go through the same set of computing devices, the escaped associations can cause data corruption in email data. This invention prevents the possibility of data corruption.

### BRIEF DESCRIPTION OF THE DRAWINGS

Many aspects of the disclosure can be better understood with reference to the following drawings. The components in the drawings are not necessarily to scale. Emphasis is instead placed upon clearly illustrating the principles of the present disclosure. Moreover, in the drawings, like references numerals designate corresponding parts through the several figures.

FIG. 1 is a block diagram illustrating an example environment in which certain embodiments of the present invention may be implemented;

FIG. 2 is a block diagram illustrating an example environment in which certain embodiments of the present invention may be implemented

FIG. 3 is a block diagram illustrating an example environment in which certain embodiments of the present invention may be implemented;

FIG. 4 is a block diagram illustrating an example environment in which certain embodiments of the present invention may be implemented;

FIG. 5 is a block diagram illustrating embodiments of the present invention; and

FIG. 6 is a block diagram of a system including a network device.

### DETAILED DESCRIPTION OF EXAMPLE EMBODIMENTS

Escaped connection handling may be provided. In various embodiments, the creation of a new association group may be requested. An acknowledgement message approving the creation of a new association group with a new association group ID (server created association group ID) is sent from the server. This acknowledgment message may be intercepted en route to its destination. The server created association group ID may then be switched by the intercepting device to a transformed association group ID. A DCE/RPC association may then be established between a first computing device and a second computing device wherein acceptance of the connection to the existing association group requires the server created association group ID to be received with the connection at a second computing device and the transformed association group ID to be received with the connection at a first computing device. A plurality of TCP connections may be established between the first computing device and the second computing device. A message may be transmitted across the first TCP connection from the first computing device and the second computing device. The second computing device may determine whether the message contains the server created association group ID and transmit a connection rejection message if it does not.

Consistent with embodiments of the present invention, a system may be provided comprising an application optimizer. The application optimizer may be configured to receive a transmission with a server created association group ID. The server created association group ID of the transmission may then be switched to a transformed association group ID. The transmission may then be sent to the destination with the second association group ID. The application optimizer may then receive a transmission with the second association group ID. The transformed association group ID of the transmission may then be switched to the server created association group ID.

Consistent with embodiments of the present invention, a method may be provided comprising sending a first bind request with an association group ID of zero. A server created association group with a server created association group ID may then be created. The server created association group ID may be switched to a second association group ID in an acknowledgement message. A second bind request may then be sent with the transformed association group ID. The transformed association group ID may be switched to the server created association group ID in the second bind request after the bind request has been sent. After receiving the second bind request, it may be determined whether the association group ID in the second bind request is the same as the server created association group ID. A failure message may be sent if the association group ID in the second bind request is not the same as the server created association group ID.

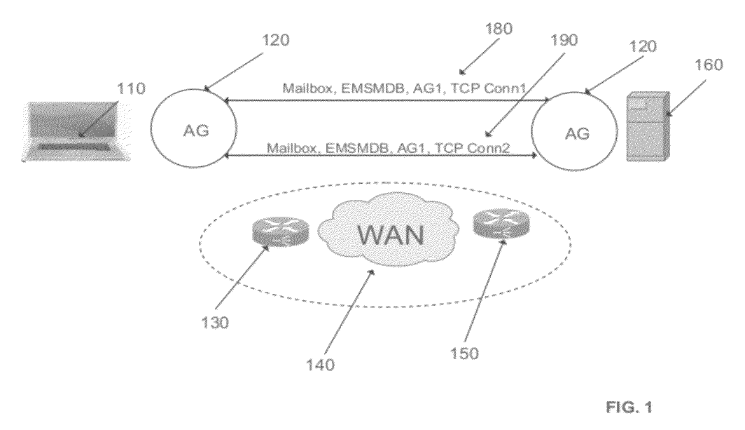

FIG. 1 is a block diagram illustrating a network environment in which certain embodiments of the present invention may be implemented. For example, client 110 may be a user of a personal computer at a residence. While client 110 is illustrated here as a personal computer, client 110 may be any computing device capable of establishing TCP connections to facilitate the transfer of data. Client 110 may communicate to a server 160 by establishing a first TCP connection 180 and a second TCP connection 190. The TCP connections may travel across a WAN 140. Located on WAN 140 may be a plurality of computing devices such as computing device 130 and computing device 150. As discussed above, the computing devices may be routers or switches.

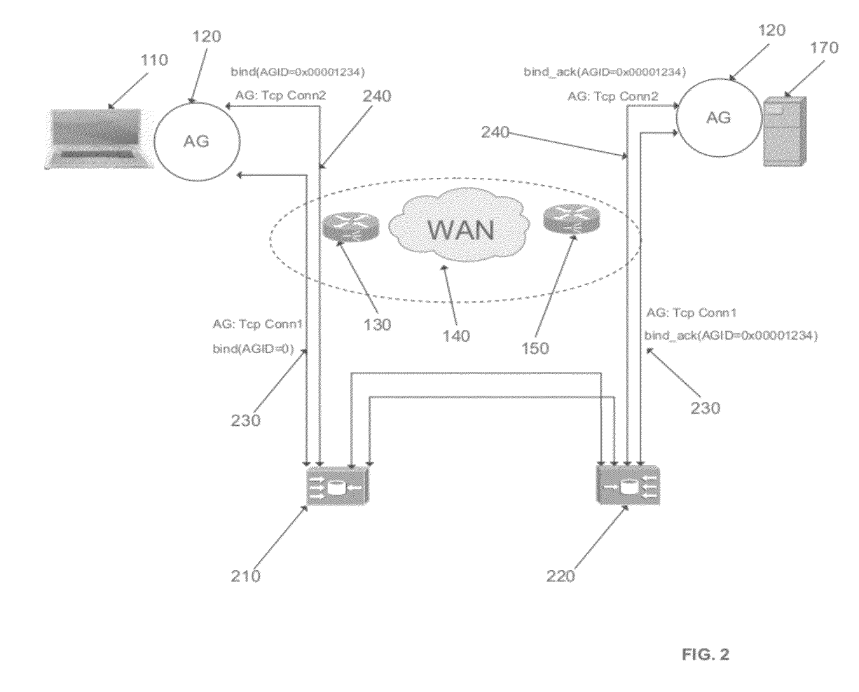

Turning to FIG. 2, Client 110 may be a member of an association group 120. Client 110 may request the creation of a new association group 120 by sending a bind Protocol Description Unit (“PDU”) 230 with an Association Group ID (“AGID”)=0. The bind request may be received by a server 170. Server 170 may subsequently create the association group 120 and return the AGID of association group 120 to client 110 on message 260. Client 110 may then create association group 120. Association group 120 may employ the returned AGID.

After the establishment of a first Remote Procedure Call (“RPC”) association, client 110 may next create a second RPC association belonging to association group 120. To accomplish this, client 110 may send a bind PDU request 240 with the AGID received during the creation of the first RPC association. Server 170 will add the second RPC association to establish the connection and return a bind acknowledgement 250 with the same AGID.

As such, two associations have been established as belonging to the association group 120. Association group 120 may have any number of connections in it (depending on the load). There is a 1:1 relationship between an RPC association and the underlying TCP connection. For example, the RPC runtime on both client 110 and server 170 has a data structure for each TCP/IP connection. Each connection must belong to exactly one association group 120. Once a connection is tied to an association group 120, a connection may not change the association group that it belongs to. Association group 120 and other association groups may be uniquely identified by the 3-tuple—{Destination IP, Destination Port, Association Group ID}.

In the examples illustrated by FIGS. 1 and 2, each of the messages may travel through computing device 210 and computing device 220 between client 110 and server 120. In embodiments of the present invention, computing device 210 may be an Client side Messaging Application Programming Interface (“MAPI”) Application Optimizer (“AO”) that works with the server side MAPI AO on the computing device 220.

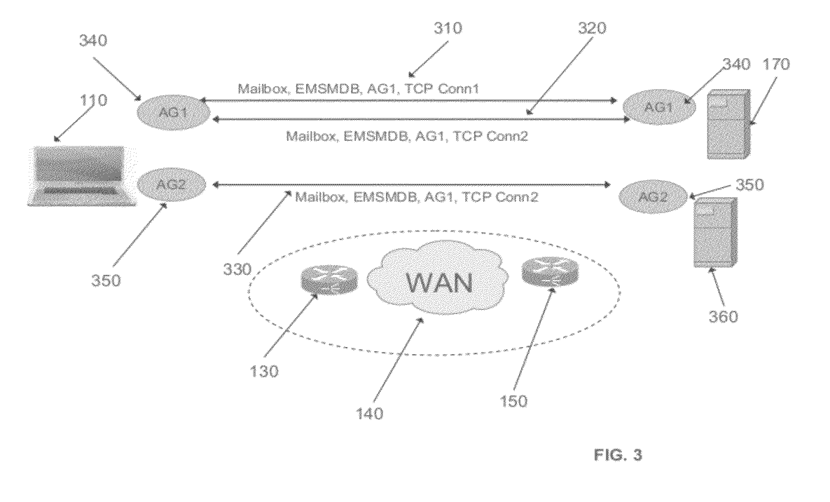

FIG. 3 is a block diagram illustrating a network environment in which certain embodiments of the present invention may be implemented. Here, two association groups 340 and 350 are established. Association group 340 has two TCP connections 310 and 320 to mail server 170. Association group 350 has a TCP connection 330 to public mail folders 370. For example, public mail folders 370 may be stored in a remote data center or server farm. It should be noted that there could be more or less TCP connections in an association group depending on the load and on user settings. Furthermore, the number of association groups may be determined by user settings and application plug-ins used by client 110.

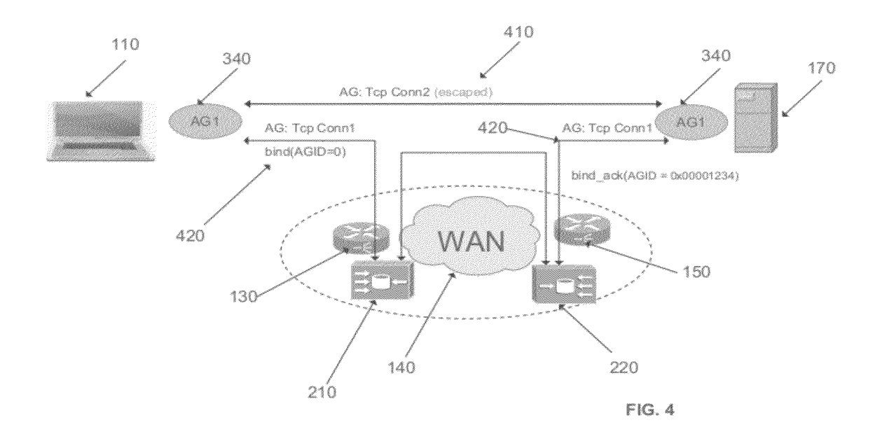

Referring now to FIG. 4, Edge MAPI AO 210 may have design requirements that all connections belonging to an association group, such as association group 340, must be intercepted by the same Edge MAPI AO 210. The Edge MAPI AO 210 may maintain a state such as (file read/write offset, etc.) that is specific to a session.

Association group 340 may be established with a first TCP connection 420. For example, client 110 may send a bind( ) PDU with AGID=0 to request creation of association group 340. Server 170 may subsequently create association group 340 and return the AGID=AG1. Client 110 may then create new association belonging to association group 340 with the server created AGID=AG1.

The second TCP connection 410 may subsequently be created belonging to association group 340. However, as illustrated in FIG. 4, TCP connection 420 escapes the interception requirement and fails to travel through Edge MAPI AO 210. TCP connection 420 may escape due to a number of reasons including router misconfiguration.

As such, TCP connection 420 may bypass Edge MAPI AO 210. Client 110 may send a bind( ) PDU with AGID=AG1. Server 170 may then admit the new connection into association group 340 resulting in a valid RPC transport on an escaped connection. Escaped connections can result in unexpected behavior including connection disconnects, duplicated E-mails, and failures with send and receive operations.

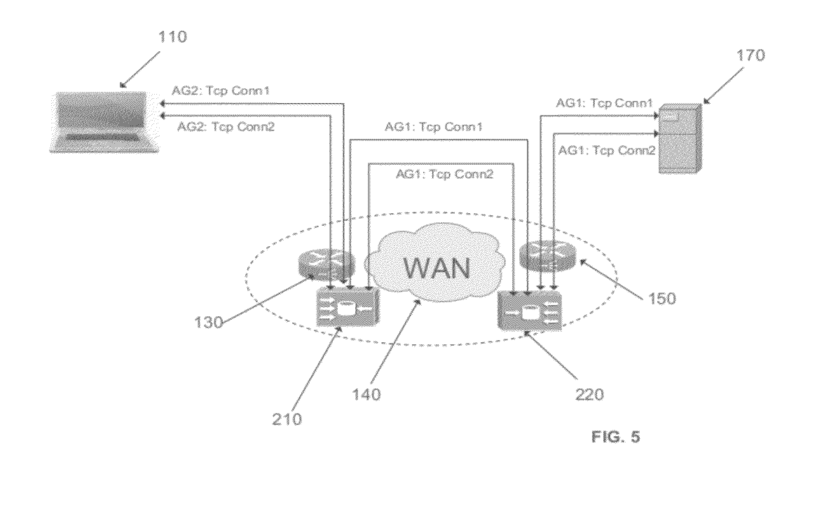

FIG. 5 illustrates embodiments of the present invention to prevent escaped connections. Here, edge MAPI AO 210 switches the AGID created by server 170 as shown below. Client 110 may send bind( ) PDU with AGID=0 to request creation of a new association group. Server 170 may receive the request and create association group 1 and return bind_ack with the AGID=AG1. Edge MAPI AO 210 may intercept the bind_ack and switch the AGID to AG2.

Embodiments of the present invention comprise a client sending a bind( ) PDU with a zero AGID (requesting the creation of a new association group). A server may create an association group and return a bind acknowledgment comprising AGID=AGID1. An optimizer may then switch the AGID in the bind acknowledgement to AGID2. For a second connection, the client may send a bind( ) PDU with a second association group. The optimizer may switch the AGID to AGID1. As a result, the server can admit the new connection to the first association group.

The AGID switching function of this invention can be any F: X→Y in which:
a. (0<X<2̂32) and (XεZ)
b. (0<Y<2̂32) and (YεZ)
c. a≠F[a] for any aεX
d. if (F[a]=F[b] for any a,bεX) implies a=b

In some embodiments of the present invention, the AGID switching function can be represented as AG2=(0x8000 0000)̂(AG1) or AG2=(0x8000 0000) XOR (AG1). Advantages to this switching function include its simplicity. Furthermore, such a switching function makes it easier to correlate the switched AGID with the original AGID for debugging purposes. Also, this approach may retain the monotonically increasing nature of AGIDs. Lastly, this approach may make it very unlikely for the AGIDs to wrap and cause conflict.

Now, a second TCP connection belonging to the association group may be desired. Client 110 may send bind( ) PDU with AGID=AG2. Edge MAPI AO 210 may intercept the bind( ) and switch the AGID to AGID=AG1. Next, server 170 admits the new connection into AG1. An advantage of embodiments of the present invention is that a user at client 110 or server 170 does not need or have visibility of the AGID changes.

In these embodiments, an attempted “escaped connection” is handled when the bind( ) on the escaped connection reaches server 170. Server 170 will not recognize the provided AGID and the attempt will fail. Server 170 may return a bind_nak( ) message in response. At this point, client 110 may retry with a new connection. If the new attempted connection escapes again, it would result in a repeat of the rejection at server 170 as described above. In some embodiments, client 110 may retry approximately ˜40 times and consistently get bind_nak responses in return before termination.

If the connections keep escaping in this way, the time frame of these retries may be adjusted based on WAN conditions. For example, 40 ms Round Trip Time (“RTT”)—˜3 sec; 200 ms RTT—˜18 s; 400 ms RTT—˜38 s; and LAN conditions—˜1 sec. It should be understood that these retry time frames may be adjusted to any period of time based on user preferences. If the connections keep escaping in this way then after the pre-determined number of retries the client may discard the AGID and creates a new association group.

The above example considers the case where all the new TCP connections escape to the server (to simulate the worst-case scenario). In a practical deployment, the network conditions causing the “escape” may be transient and thus reduce this window of potential escaped connections.

In embodiments of the present invention, it may be necessary to have the AGID switch only at Edge MAPI AO 210. The switching logic itself may also be contained within Edge MAPI AO 210. In some embodiments, handed-off connections after the AGID is switched may be entered into a table which tracks the activities of an association group. Such a table may be beneficial to help ensure that Edge MAPI AO 210 switches the AGID for subsequent new connections belonging to the same association group.

Embodiments of escaped connection prevention may be implemented in hardware, software, firmware, or a combination thereof (collectively or individually also referred to herein as logic). To the extent certain embodiments, or portions thereof, are implemented in software or firmware, executable instructions or code for performing one or more tasks of escaped connection prevention are stored in memory or any other suitable computer readable medium and executed by a suitable instruction execution system. In the context of this document, a computer readable medium is an electronic, magnetic, optical, or other physical device or means that can contain or store a computer program for use by or in connection with a computer related system or method.

To the extent certain embodiments, or portions thereof, are implemented in hardware, escaped connection prevention may be implemented with any or a combination of the following technologies: a discrete logic circuit(s) having logic gates for implementing logic functions upon data signals, an application specific integrated circuit (ASIC) having appropriate combinational logic gates, programmable hardware such as a programmable gate array(s) (PGA), a field programmable gate array (FPGA), etc.

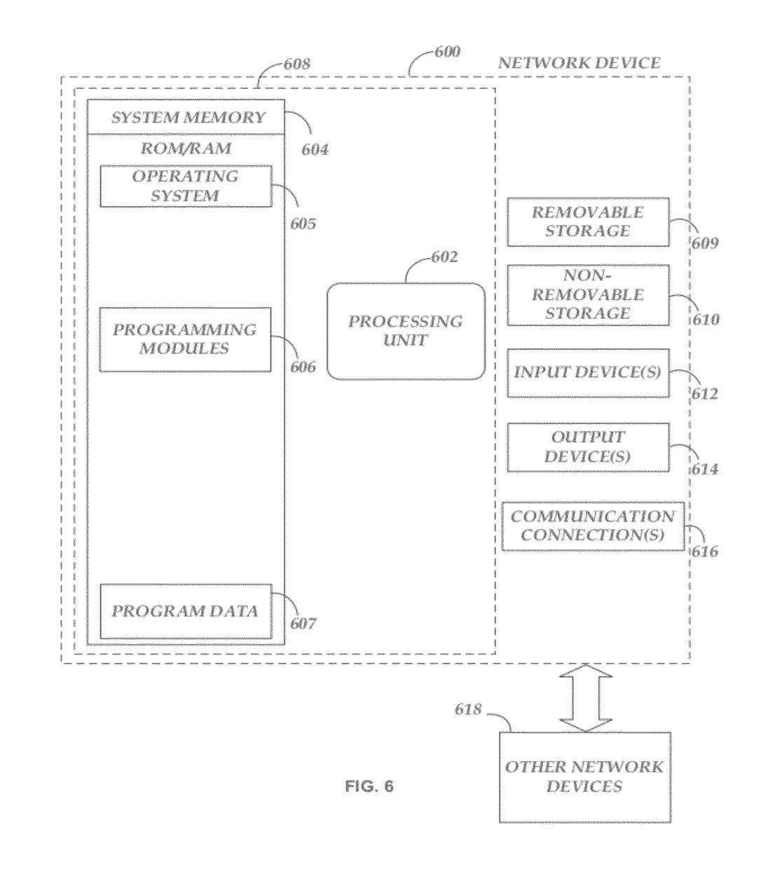

FIG. 6 is a block diagram of a system including network device 600. Consistent with embodiments of escaped connection prevention, the aforementioned memory storage and processing unit may be implemented in a network device, such as network device 600 of FIG. 6. Any suitable combination of hardware, software, or firmware may be used to implement the memory storage and processing unit. For example, the memory storage and processing unit may be implemented with network device 600 or any of other network devices 618, in combination with network device 600. The aforementioned system, device, and processors are examples and other systems, devices, and processors may comprise the aforementioned memory storage and processing unit, consistent with embodiments of escaped connection prevention. Furthermore, network device 600 may comprise an operating environment for system 100 as described above. System 100 may operate in other environments and is not limited to network device 600.

With reference to FIG. 6, a system consistent with embodiments of escaped connection prevention may include a network device, such as network device 600. In a basic configuration, network device 600 may include at least one processing unit 602 and a system memory 604. Depending on the configuration and type of network device, system memory 604 may comprise, but is not limited to, volatile (e.g., random access memory (RAM)), non-volatile (e.g., read-only memory (ROM)), flash memory, or any combination. System memory 604 may include operating system 605, one or more programming modules 606, and may include a program data 607. Operating system 605, for example, may be suitable for controlling network device 600′s operation. Furthermore, embodiments of escaped connection prevention may be practiced in conjunction with a graphics library, other operating systems, or any other application program and is not limited to any particular application or system. This basic configuration is illustrated in FIG. 6 by those components within a dashed line 608.

Network device 600 may have additional features or functionality. For example, network device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by network device 600. Any such computer storage media may be part of device 600. Network device 600 may also have input device(s) 612 such as a keyboard, a mouse, a pen, a sound input device, a touch input device, etc. Output device(s) 614 such as a display, speakers, a printer, etc. may also be included. The aforementioned devices are examples and others may be used.

Network device 600 may also contain a communication connection 616 that may allow device 600 to communicate with other network devices 618, such as over a network in a distributed network environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 may perform processes including, for example, one or more method 500's stages as described above. The aforementioned process is an example, and processing unit 602 may perform other processes.

Generally, consistent with embodiments of escaped connection prevention, program modules may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable consumer electronics, minicomputers, mainframe computers, and the like. Embodiments of escaped connection prevention may also be practiced in distributed network environments where tasks are performed by remote processing devices that are linked through a communications network. In a distributed network environment, program modules may be located in both local and remote memory storage devices.

Furthermore, embodiments of escaped connection prevention may be practiced in an electrical circuit comprising discrete electronic elements, packaged or integrated electronic chips containing logic gates, a circuit utilizing a microprocessor, or on a single chip containing electronic elements or microprocessors. Embodiments may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of escaped connection prevention, for example, may be implemented as a computer process (method), a network system, or as an article of manufacture, such as a computer program product or computer readable media. The computer program product may be a computer storage media readable by a computer system and encoding a computer program of instructions for executing a computer process. The computer program product may also be a propagated signal on a carrier readable by a network system and encoding a computer program of instructions for executing a computer process. Accordingly, aspects of escaped connection prevention may be embodied in hardware and/or in software (including firmware, resident software, micro-code, etc.). In other words, embodiments of escaped connection prevention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of escaped connection prevention.

At least the following is claimed:

1. A method comprising:
requesting creation of a first association group with a server-created association group ID;
intercepting an acknowledgement message approving the creation of the first association group;
switching the server-created association group ID to a transformed association group ID;
establishing a connection between a first computing device and a second computing device wherein acceptance of the connection requires the server-created association group ID to be received with the connection at a second computing device and the transformed association group ID to be received with the connection at a first computing device.

2. The method of claim 1, wherein the first computing device is a client and the second computing device is an electronic mail server.

3. The method of claim 1, wherein the connection is a TCP connection.

4. The method of claim 1, wherein the step of switching is performed by a third computing device.

5. The method of claim 4, wherein the third computing device is an Edge MAPI application optimizer.

6. The method of claim 1, wherein the switching is accomplished with an XOR switching function on the first association group ID.

7. The method of claim 3, wherein a plurality of TCP connections are established between the first computing device and the second computing device.

8. The method of claim 7, further comprising:
transmitting a message across the first TCP connection from the first computing device and the second computing device;
determining at the second computing device that the message contains the first association group ID; and
transmitting a connection rejection message.

9. The method of claim 8, further comprising retrying transmission of the message for a pre-determined number of times.

10. The method of claim 9, wherein the retrying to transmit step is performed at pre-determined time intervals.

11. The method of claim 4, wherein receiving the recovered virtual congestion level comprises receiving the recovered virtual congestion level comprising a low-pass filtered observation of the calculated virtual congestion level.

12. A system comprising:
an application optimizer configured to:
receive a transmission with a first association group ID;
switch the first association group ID of the transmission to a second association group ID;
transmit the transmission with the second association group ID.

13. The system of claim 12, wherein the application optimizer is one of a router or a server.

14. The system of claim 13, wherein the application optimizer resides on a wide area network.

15. The system of claim 14, wherein the application optimizer is further configured to:
receive a transmission with the second association group ID;
switch the second association group ID of the transmission to the first association group ID;
transmit the transmission with the first association group ID.

16. A method comprising:
sending a first bind request with an association group ID of zero;
creating a first association group with a first association group ID;
switching the first association group ID to a second association group ID in an acknowledgement message;
sending a second bind request with the second association group ID; and
switching the second association group ID to the first association group ID in the second bind request after the bind request has been sent.

17. The method of claim 16, further comprising the steps of:
receiving the second bind request;
determining whether the association group ID in the second bind request is the same as the first association group ID; and
sending a failure message if the association group ID in the second bind request is not the same as the first association group ID

18. The method of claim 17, further comprising resending the second bind request at pre-determined intervals.

19. The method of claim 18, wherein if the second bind request fails a pre-determined number of times, requesting the creation of a new association group.

20. The method of claim 16, wherein the switching is accomplished with an XOR switching function performed on the association group ID.
